(19) United States
(12) Patent Application Publication
(10) Pub. No.: US 2025/0034906 A1
(43) Pub. Date: Jan. 30, 2025

(54) MECHANICAL LOCK PASSWORD SETTING AND RESET STRUCTURE

(71) Applicant: SHENZHEN HUIKAIDA TECHNOLOGY CO., LTD, Shenzhen (CN)

(72) Inventor: HE ZHANG, Guangzhou (CN)

(21) Appl. No.: 18/465,378

(22) Filed: Sep. 12, 2023

(30) Foreign Application Priority Data
Jul. 24, 2023 (CN) 202310910995.4

(51) Int. Cl. E05B 37/00; E05B 9/00; E05B 13/00

(52) U.S. Cl. CPC E05B 37/0048; E05B 9/002; E05B 13/002

(57) ABSTRACT

A mechanical lock password setting and reset structure, including: a face cover, the face cover with a skeleton, a positioning spring between the skeleton, the side of the skeleton, the reset plate with a side cover, a spring and a cam between the reset plate and the lock plate, the back of the bottom cover of the pressure plate, the rubber spring, a key cover, the key and the key, respectively. The present invention, the present invention provides a mechanical lock password setting and reset structure, this design can replace the now the traditional mechanical password lock internal complex structure, can improve the convenience of installation, and prevent the loss of separate parts during long-term use.

### CROSS REFERENCE TO RELATED APPLICATIONS

The present application claims the priority of Chinese patent application No. 2023109109954, filed on Jul. 24, 2023, and contents of which are incorporated herein by its entireties.

### TECHNICAL FIELD

The present disclosure relates to the field of mechanical lock, in particular to the password setting and reset structure of a mechanical lock.

### BACKGROUND

Mechanical lock is a kind of full mechanical password lock with large key quantity and high reliability without electronic devices.

The current mechanical lock can be divided into two kinds of password mechanical lock and key mechanical lock, however, the traditional mechanical password lock codon is relying on each codon, install independent spring and hook to realize the codon positioning and reset, more complex parts assembly, the user to set the password, difficult to replace installation, the user long-term use replacement is easy to lose parts.

To solve the above problems, it is necessary to provide a mechanical lock password setting and reset structure to solve the above technical problems.

### SUMMARY

The present disclosure provides a mechanical lock password setting and reset structure, which solves the problem that the parts inside the transmission mechanical password lock are complex, it is difficult to replace the installation when the user reset the password, and the user easily loses the parts during long-term use.

In order to realize the above objective, the present disclosure adopts technical solutions as follows.

Mechanical lock, witch include face cover, reduction plate, press plate,

Said face cover is the cap is provided with a skeleton, a positioning spring is provided between the cover and the skeleton, a side of the skeleton;

Said reduction plate is the reset plate has a side of the surface cover, a spring and a cam between the reset plate and the locking plate, and the back side of the cover is connected with a bottom plate;

Said press plate is the inside of the press plate cover, the pressure surface is provided with a rubber spring, the surface of the rubber spring is provided with a password cover, the inside and the press plate is provided with a key, a codon key and a codon key, respectively.

In some embodiment, the cap is provided with a connecting tube that is provided with a lock core.

In some embodiment, one end of the lock core is connected with a front knob and the bottom plate is provided with a square bar.

In some embodiment, the end of a square cover is provided with a rear cover and one end of the rear cover is connected with a rear knob.

In some embodiment, the front knob and the rear knob act on the rotation of the lock core.

In some embodiment, the codon opening and the codon function in the opening and closing of the lock core.

In some embodiment, a fixed connection between the reset plate, the locking plate, the skeleton and the bottom plate.

In some embodiment, the surface of the face cover is provided with a protective assembly including two rectangular plates, the surface of both rectangular plates is grooves, and the interior of the two grooves is connected with a sliding block.

In some embodiment, both surfaces of the two slides are connected to connecting racks and protective plates are connected between the two connections.

In some embodiment, the sides of the slide block opposite the groove have the groove and the magnetic block.

Compared with related arts, the present disclosure at least has following beneficial effects.

The present disclosure provides a mechanical lock password setting and reset structure, in which provides the coordination operation between the skeleton, positioning spring, locking plate, reset plate, spring, cam, key, rubber spring, press plate, and codon key, with the replacement of the complex structure inside the traditional mechanical password lock, respectively in the face cover, and prevent the loss of separate parts during long-term use.

### BRIEF DESCRIPTION OF DRAWINGS

FIG. 1 is a schematic diagram of a first embodiment of a reset structure;

FIG. 2 is a schematic diagram of the structure installed between the locking plate and the cam as shown in FIG. 1;

FIG. 3 is a schematic diagram of the operation between the locking plate and the cam shown in FIG. 2;

FIG. 4 is a diagram of the stereoscopic structure installed between the locking plate, cam and reset plate shown in FIG. 1;

FIG. 5 is the mounted view between the locking plate, the cam and the reset plate shown in FIG. 4;

FIG. 6 is a schematic diagram of the stereoscopic structure installed between the square bar, the lock body and the front knob shown in FIG. 1;

FIG. 7 is a schematic diagram of the stereostructure installed between the reset plate, codon bond and codon key shown in FIG. 1;

FIG. 8 is a side view of the installation between the reset plate, codon key and codon key shown in FIG. 7;

FIG. 9 is a schematic diagram of the stereoscopic structure installed between the reset plate, the cam, the connecting pipe and the front knob as shown in FIG. 1;

FIG. 10 is a schematic diagram of the cam operation shown in FIG. 1;

FIG. 11 is a schematic diagram of the structure working between the skeleton, positioning spring, codon opening bond and codon key shown in FIG. 1;

FIG. 12 is a schematic diagram of the stereo structure installed between the skeleton, positioning spring, locking plate, codon opening bond, surface cover and codon key shown in FIG. 1;

FIG. 13 shows the working structure between skeleton, positioning spring, locking sheet, codon opening bond, face cover and codon key shown in FIG. 12;

FIG. 14 is a schematic diagram of the stereoscopic structure of the mechanical code lock shown in FIG. 1.

In the figures, the representation of each reference sign is as follows.

1, key, 2, code cover, 3, rubber spring, 4, codon key, 5, codon key, 6, front knob, 7, lock core, 8, connecting tube, 9, face cover, 10, positioning spring, 11, skeleton, 11,12, lock plate, spring, 13,14, cam, 15,15, reset plate, 16, square plate, 17,18, lock body, 19, back cover, 20, rear knob, 21, pressure plate.

### DETAILED DESCRIPTION

Implementations of the present disclosure will now be described, by way of embodiments only, with reference to the drawings. It should be understood that the specific embodiments described here are only used to explain but not to limit the present application. Based on the embodiments in the present application, all other embodiments obtained by one ordinary skill in the art without creative labor is within the scope of the present application.

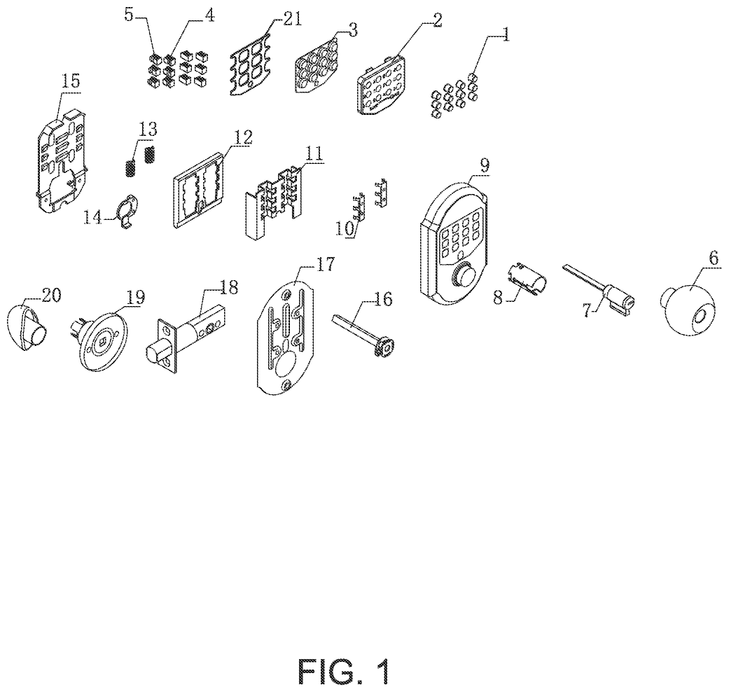

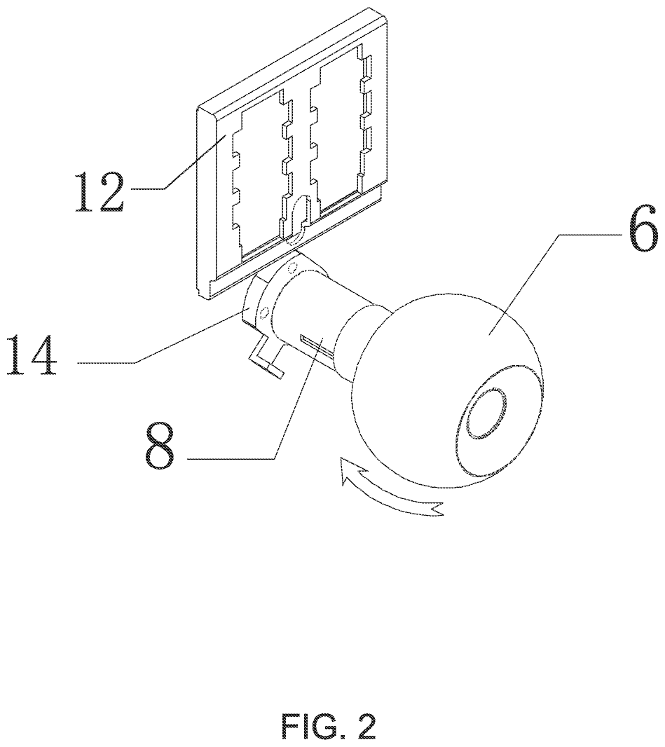

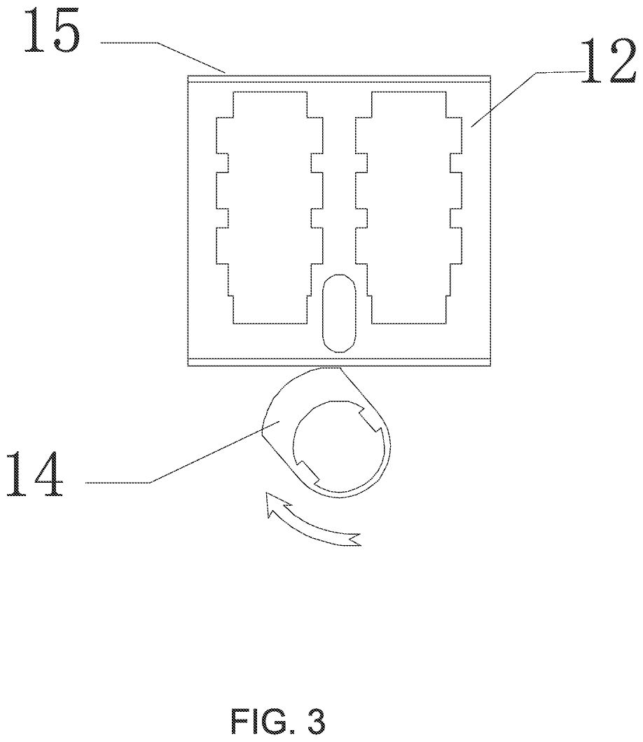

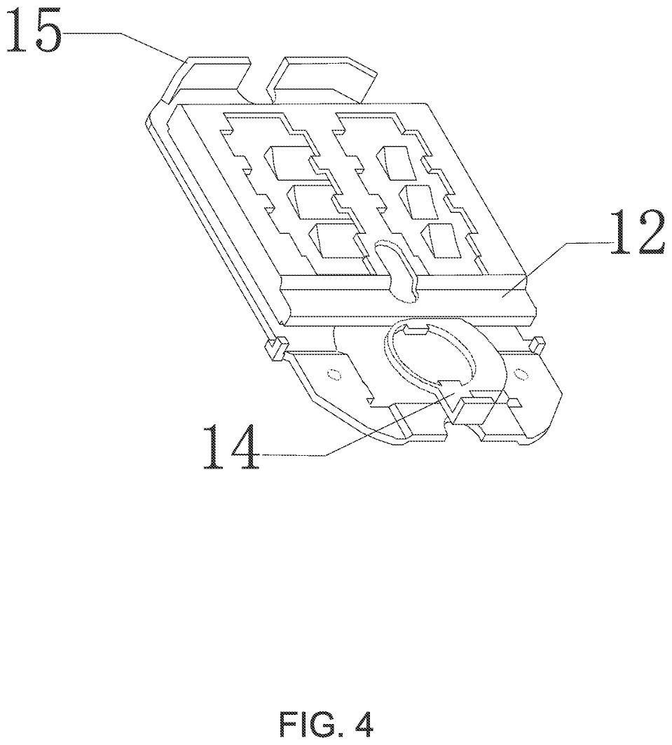

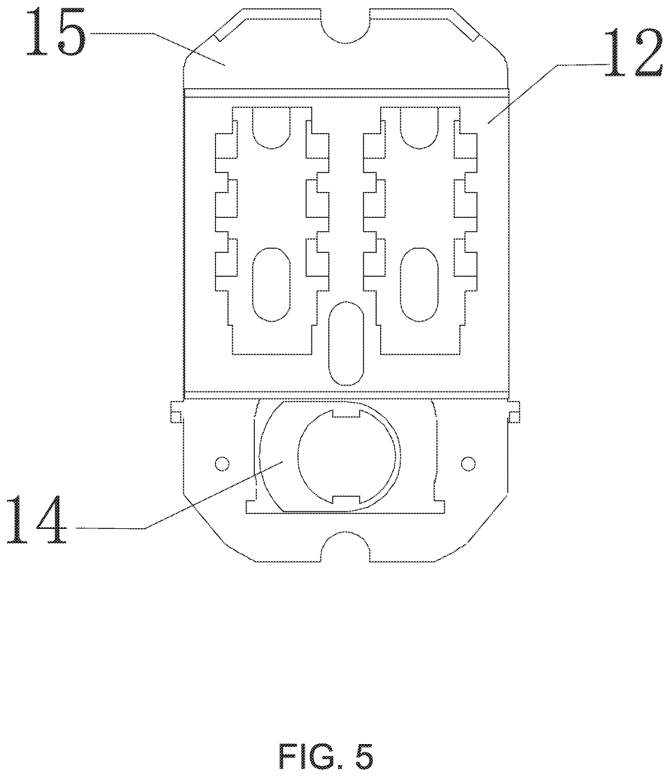

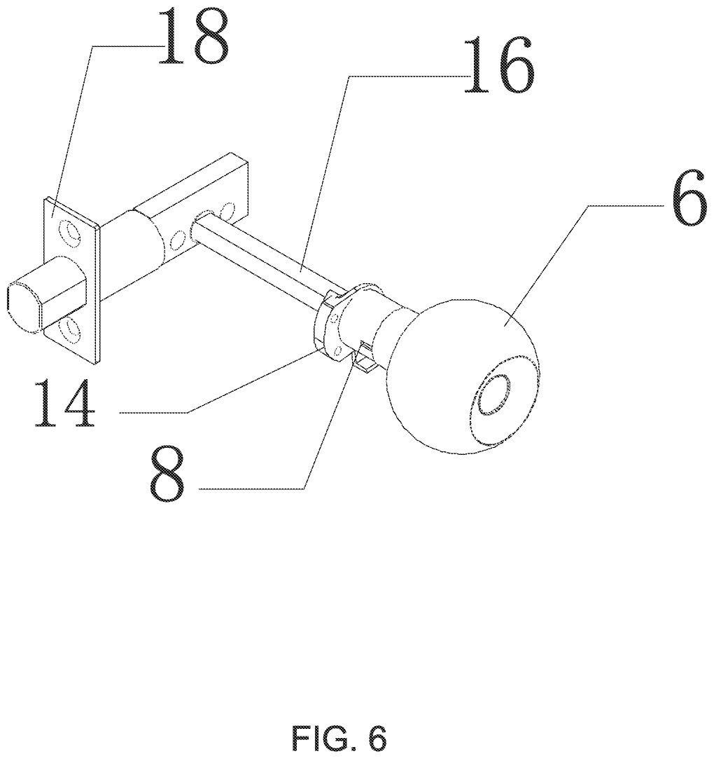

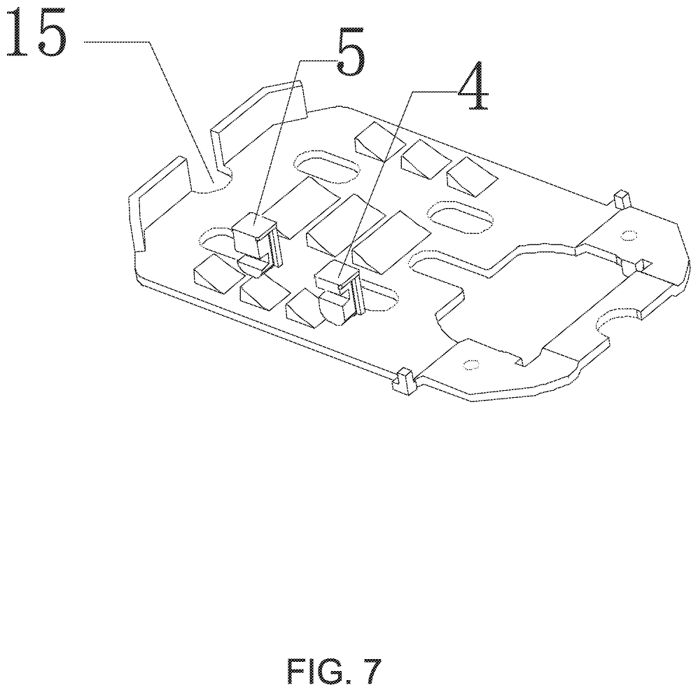

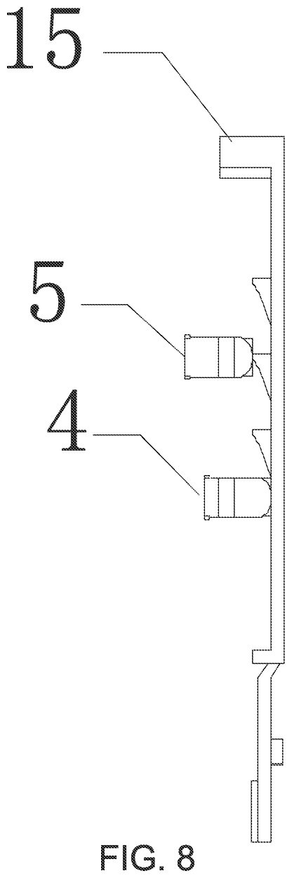

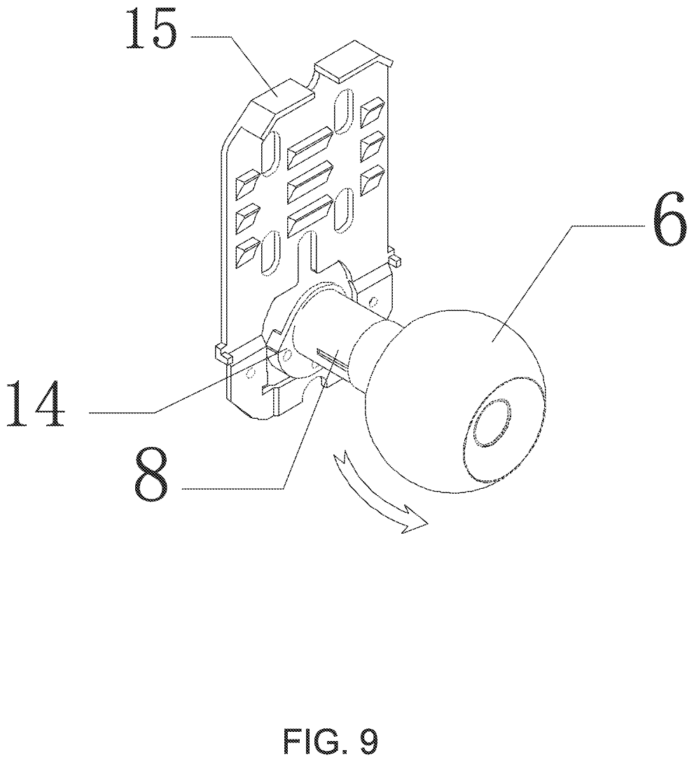

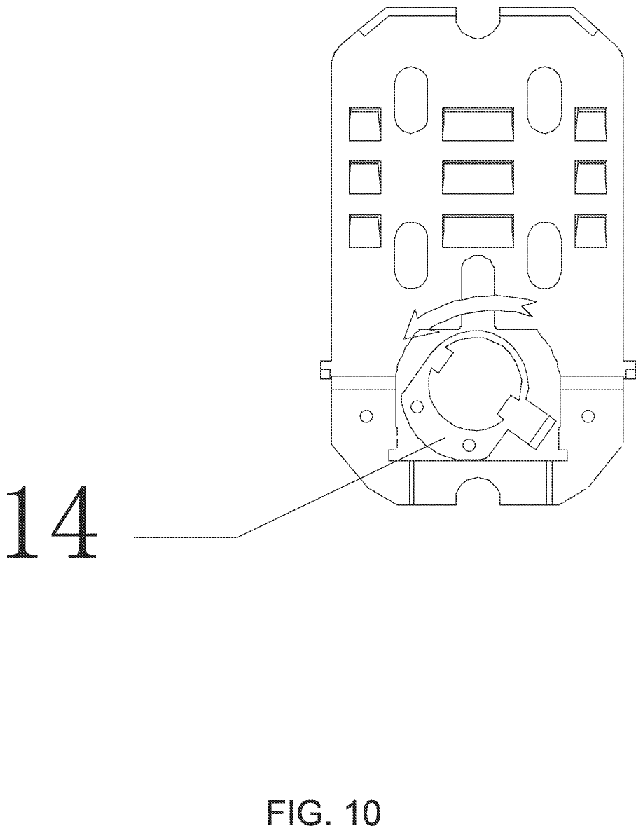

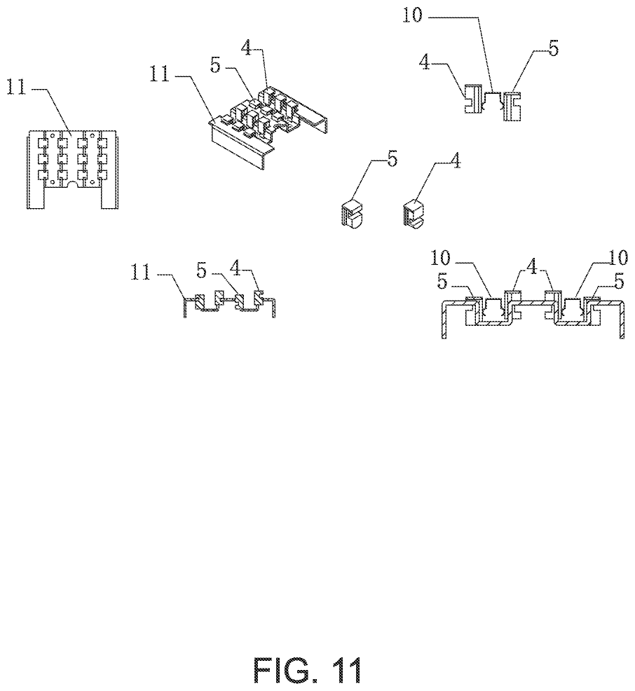

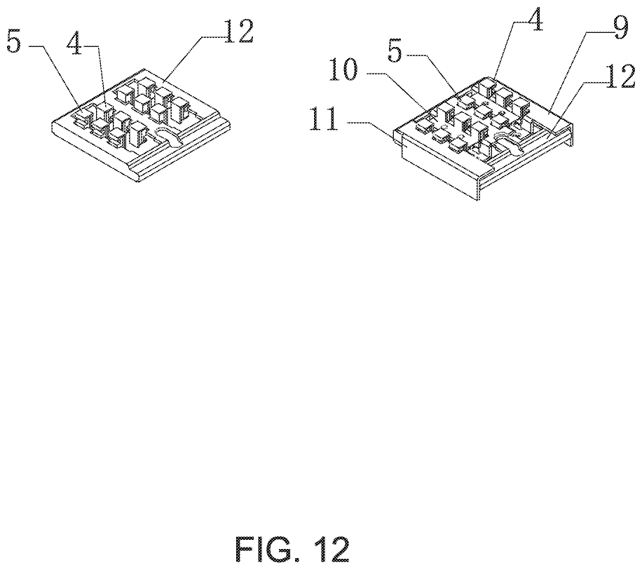

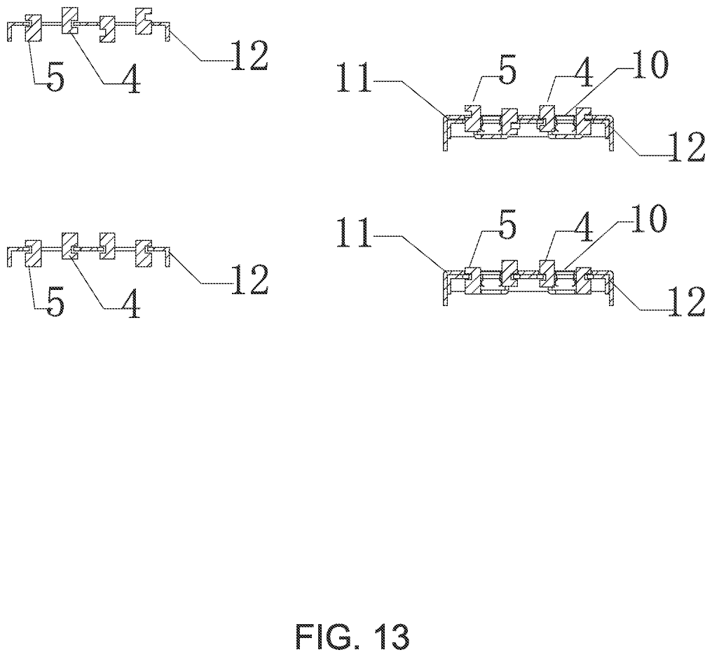

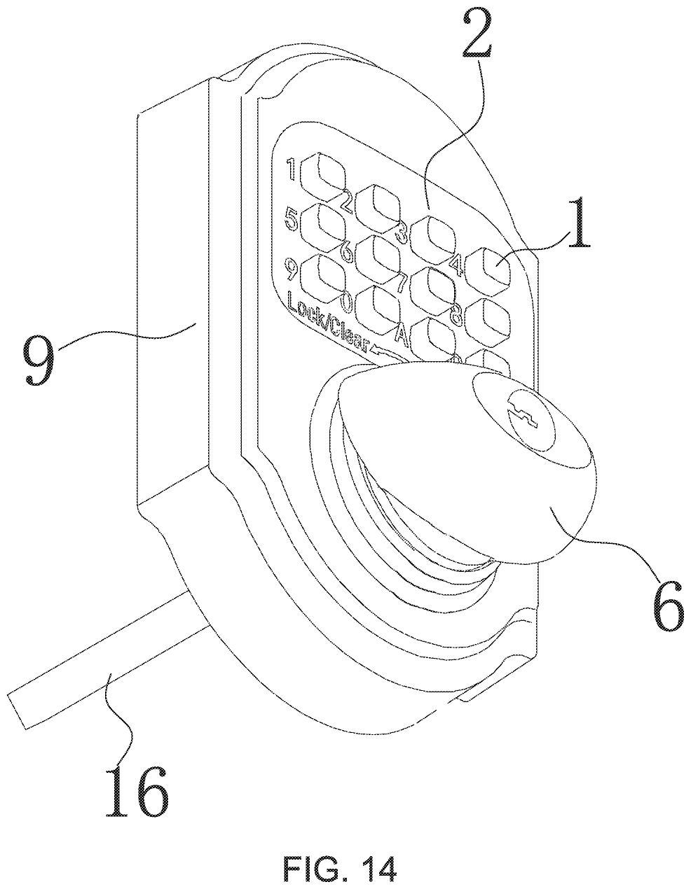

Referring to FIGS. 1-14, in the mechanical lock of the disclosure, FIG. 1 is a schematic diagram of a first embodiment of a reset structure; FIG. 2 is a schematic diagram of the structure installed between the locking plate and the cam as shown in FIG. 1; FIG. 3 is a schematic diagram of the operation between the locking plate and the cam shown in FIG. 2; FIG. 4 is a diagram of the stereoscopic structure installed between the locking plate, cam and reset plate shown in FIG. 1; FIG. 5 is the mounted view between the locking plate, the cam and the reset plate shown in FIG. 4; FIG. 6 is a schematic diagram of the stereoscopic structure installed between the square bar, the lock body and the front knob shown in FIG. 1; FIG. 7 is a schematic diagram of the stereostructure installed between the reset plate, codon bond and codon key shown in FIG. 1; FIG. 8 is a side view of the installation between the reset plate, codon key and codon key shown in FIG. 7; FIG. 9 is a schematic diagram of the stereoscopic structure installed between the reset plate, the cam, the connecting pipe and the front knob as shown in FIG. 1; FIG. 10 is a schematic diagram of the cam operation shown in FIG. 1; FIG. 11 is a schematic diagram of the structure working between the skeleton, positioning spring, codon opening bond and codon key shown in FIG. 1; FIG. 12 is a schematic diagram of the stereo structure installed between the skeleton, positioning spring, locking plate, codon opening bond, surface cover and codon key shown in FIG. 1; FIG. 13 shows the working structure between skeleton, positioning spring, locking sheet, codon opening bond, face cover and codon key shown in FIG. 12; FIG. 14 is a schematic diagram of the stereoscopic structure of the mechanical code lock shown in FIG. 1. A mechanical lock password setting and reset structure comprising:
A face cover 9 provided with a skeleton 11, a positioning spring 10 provided between the frame 11, and a locking plate 12 mounted on one side of the frame 11;
Return plate 15, the return plate 15 having a side of the face cover 9, a spring 13 between the return plate 15 and the locking plate 12, a back side of the face cover 9 connected to the bottom plate 17;
The pressing plate 21, the pressing plate 21, the pressing surface 21 and the rubber spring 3, the surface of the rubber spring 3 is provided with the code cover 2, the pressing plate 21 and the key 1, the key 1 and the codon key 5, the back of the key 1 has the silicone pressing block, the reduction after the pressing of the key 1, thus keeping the feel of each key, and thus increasing the authorization rate.

The inner cover 9 is provided with a connection tube 8, and the inner cover 8 is provided with a lock core 7.

One end of the lock core 7 is connected with a front knob 6 and the bottom plate 17 is provided with a bar 16.

The face cover 9 is provided with an end of a square bar 16 and a lock body 18 is provided with a rear cover 19 and one end of the rear cover 19 is connected with a rear knob 20.

The front knob 6 and the rear knob 20 are applied on rotation of the lock core 7.

The codon opening 4 and the codon key 5 act on the opening and closing of the lock core 7, and the codon opening 4 and the codon key 5 can be set accordingly according to the needs of the password before use, and the password can be changed in the same way.

The reset plate 15, the locking plate 12, the skeleton 11 and the bottom plate 17 are fixed connected.

Referring to FIGS. 7 and 8 and see that the reset plate 15 lifts the codon key 4 and the codon key 5 by using the inclined plane.

Referring to FIGS. 9 and 10, the cam 14 rotates the reset plate 15 downward.

Referring to FIGS. 2 and 3, the cam 14 rotates the locking sheet 12 upward.

Referring to FIG. 4 and FIG. 5 to rotate the cam 14 through the front knob 6, dial the lock plate 12 or the reset plate 15 to unlock or reset, clockwise the lock plate 12 and counterclockwise the reset plate 15, the codon key 4 and the codon key 5.

Referring to FIG. 6 to know that when the front knob 6 rotates, the cam 14 and square bar 16 rotates, square, 16 drives the lock body 18 to unlock and lock.

Referring to FIG. 11 and learn that codon key 4 and codon key 5 have a groove inserted into the convex groove of skeleton 11.

Referring to FIG. 13 to know that the codon open key 4 and the codon key 5 reset or press the wrong, the lock slider can not pass;

When codon key 4 is pressed and codon key 5 is pressed.

Referring to FIG. 7, codon key 4 and codon key 5 structure exists at the bottom of the height drop, when pressing, codon key 4 can allow the knob 6 rotation, codon key 5 pressed will lead to the knob 6 can not rotate, using positioning spring 10 provide lateral clamp, clamp the codon key 4 and key 5 height, thus positioning in use, combined with the overall reset.

By rotating the front knob 6 drive the reset plate 15 up and down, counterclockwise rotary knob 6 can drive the reset plate 15 move, using the slope to press the codon key 4 and codon key 5 lift the codon key 4 and codon key 5 reset, greatly simplify the number of parts, production assembly user set the difficulty of the password.

The present invention, provides a mechanical lock password setting and the reset structure working principle as follows:
In use, the reset plate 15 locks or reset the codon key 5, and clockwise moves the lock plate 12 to unlock;
Counterclockwise is to pull the reset plate 15, namely the codon opening key 4 and codon key 5 reset, the front knob 6 rotation to drive the cam 14 and square bar 16 rotation;
Square bar 16 drives the lock body to unlock and lock.

Compared with the related techniques, a mechanical lock password setting and reset structure provided by the present invention have the following beneficial effects:
The present disclosure provides a mechanical lock password setting and reset structure between skeleton 11, positioning spring 10, lock plate 12, reset plate 12, reset plate 15, spring 13, cam 14, key 1, codon opening 4, rubber spring 3, press plate 21, and codon key 5, replacing the complex structure within the conventional mechanical code lock, which can improve the convenience of the installation and prevent the loss of separate parts during long-term use.

The above mentioned are only the embodiments of the disclosure and do not thus limit the scope of the patent of the invention. All the equivalent structure or equivalent process transformation made by the description of the disclosure and the contents of the drawings, or directly or indirectly applied in other relevant technical fields, are similarly included in the scope of patent protection of the disclosure.

What is claimed is:

1. A mechanical lock password setting and reset structure characterized by:
Face cover, the cap is provided with a skeleton, a positioning spring is provided between the cover and the skeleton, a side of the skeleton;
Reduction plate, the reset plate has a side of the surface cover, a spring and a cam between the reset plate and the locking plate, and the back side of the cover is connected with a bottom plate;
Press plate, the inside of the press plate cover, the pressure surface is provided with a rubber spring, the surface of the rubber spring is provided with a password cover, the inside and the press plate is provided with a key, a codon key and a codon key, respectively.

2. The mechanical lock password setting and reset structure according to claim 1, wherein the face cover is provided with a connector tube and the connector tube is provided with a lock core.

3. The mechanical lock password setting and reset structure according to claim 2, wherein one end of the lock core is connected with a front knob and the bottom plate is provided with a square bar.

4. The mechanical lock password setting and reset structure according to claim 3, wherein the lock cover is provided with a square end with a lock body, the lock body surface is provided with a back cover, and one end of the back cover is connected with a rear knob.

5. The mechanical lock password arrangement and reset structure according to claim 4, wherein the front knob and the rear knob are applied on the rotation of the lock core.

6. The mechanical lock password setting and reset structure according to claim 2, wherein the codon opening and the codon function function on the opening and closing of the lock core.

7. The mechanical lock password arrangement and reset structure according to claim 3, the reset plate, the locking sheet, the skeleton and the bottom plate.

8. The mechanical lock password setting and reset structure according to claim 1, wherein the surface of the face cover is provided with a protective assembly, the protective component comprising two rectangular plates, the surface of the two rectangular plates are provided with a slide, and the interior of the two slides are connected with a slide.

9. The mechanical lock password arrangement and reset structure according to claim 8, wherein the surfaces of the two slides are connected with a connecting frame and the protective plates are connected between the two connecting frames.

10. The mechanical lock password arrangement and reset structure according to claim 9, wherein the groove of the slide and the opposite sides of the groove are provided with a magnetic block.
